(19) United States
(12) Patent Application Publication
(10) Pub. No.: US 2026/0233591 A1
(43) Pub. Date: Aug. 13, 2026

(54) Roller Shading Arrangement for Vehicle

(71) Applicant: Ruifang Xiang, Riverside, CA (US)

(72) Inventor: Ruifang Xiang, Riverside, CA (US)

(21) Appl. No.: 19/051,558

(22) Filed: Feb. 12, 2025

(51) Int. Cl. B60J 7/04

(52) U.S. Cl. CPC B60J 7/04

(57) ABSTRACT

Roller shading arrangement for a cargo box of a vehicle includes a cargo box opening; a driving assembly comprising a protection box located inside the cargo box; a roller shading cover including a plurality of slats movable between an open position and a closed position; and a solar panel electrically connected with the driving assembly and arranged above the driving assembly and the cargo box opening.

### FIELD OF THE DISCLOSURE

The present disclosure relates to the field of cargo box cover systems, and in particular to an automatically expandable cargo box cover system.

### BACKGROUND OF THE DISCLOSURE

Generally, trucks such as pickups with an open top cargo box can be a quite popular type of vehicle because the cargo box enables objects of various sizes to be placed and transported. Tonneau cover systems can be used to cover the top of the cargo box in a closed or extended configuration to protect the contents against dirt, debris, and other environmental contaminants and to improve the aesthetic quality thereof.

In some cases, the tonneau covers can be formed of a plurality of rectangular elements in the form of slats that are hingedly coupled together so they can be rolled up into a tubular compact, storage, open or retracted storage configuration at the front of the cargo box to allow access to the cargo box. In some cases, the tonneau covers can be formed of a plurality of rectangular elements in the form of sections that are hingedly coupled together so they can be folded up into a stacked compact, storage, open, or retracted storage configuration at the front of the cargo box.

However, despite various types of cover system has been provided in the current market, the user still needs to manually pull up and fold up the rectangular elements by their hands without having automatic power source.

Accordingly, an improved pick-up truck cargo box cover is needed.

All referenced patents, applications, and literature are incorporated herein by reference. Furthermore, where a definition or use of a term in a reference, incorporated by reference herein, is inconsistent or contrary to the definition of that term provided herein, the definition of that term provided herein applies, and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, the roller shading arrangement for a cargo box of a vehicle may comprise a cargo box opening; a driving assembly comprising a protection box located inside the cargo box; a roller shading cover comprising a plurality of slats movable between an open position and a closed position; and a solar panel electrically connected with the driving assembly and arranged on the driving assembly and the cargo box opening.

In another aspect combinable with the general implementation, the driving assembly comprises a driver positioned inside the protection box, at least one first electrical wire received inside the protection box and configured to electrically connect the solar panel and the driver.

In another aspect combinable with the general implementation, the cargo box opening comprises a front wall, a rear wall, and left and right walls extended therebetween, wherein the protection box is mounted on the front wall.

In another aspect combinable with the general implementation, the roller shading cover comprises left and right side rails supportable along and on the left and right walls of the cargo box opening respectively and a rail supporting panel extended between the left and right side rails and affixed on the left and right side rails.

In another aspect combinable with the general implementation, the driving assembly comprises a protection box having a box opening, wherein box opening is completely covered by the rail supporting panel, and the solar panel is affixed on the rail supporting panel.

In another aspect combinable with the general implementation, the plurality of slats are coupled together in the open position where the slats are longitudinally retracted towards the rail supporting panel to allow access to the cargo box opening, and in the closed position, the slats are longitudinally expanded to cover the cargo box opening.

In another aspect combinable with the general implementation, the solar panel comprises a solar panel length and a solar panel width, and the rail supporting panel comprises a rail supporting panel length and a rail supporting panel width, wherein the solar panel length is equal to the rail supporting panel length, and the solar panel width is equal to the rail supporting panel width.

In another aspect combinable with the general implementation, the rail supporting panel comprises at least one surface indentation inwardly extended from an outer surface of the rail supporting panel, wherein at least one first electrical wire of the driving assembly is embedded inside the surface indentation while the solar panel is affixed on the rail supporting panel.

In another aspect combinable with the general implementation, the plurality of slats are coupled together to define a roller shading length which is defined as a sum amount of each of a slat width of the plurality of slats, wherein each of the left and right side rails define a left side rail length and a right side rail length, wherein the left and right side rail lengths are longer than the roller shading length.

In another aspect combinable with the general implementation, the roller shading cover comprises a side indentation formed by one of the slats, the left or right side rail, and the rail supporting panel, wherein at least one first electrical wire of the driving assembly is embedded inside a surface indentation of the rail supporting panel and the side indentation while the solar panel is affixed on the rail supporting panel.

In another aspect combinable with the general implementation, the roller shading arrangement may further comprise a lighting device electrically connected with the solar panel, a switch electrically connected with the solar panel, and at least one second electrical wire embedded inside the protection box and configured to electrically connected the lighting device and the switch with the solar panel.

In another aspect combinable with the general implementation, the protection box has a box front wall, a box rear wall, box left and box right side walls integrally extended between the box front wall and the box rear wall, wherein the box front wall comprise a lighting hole configured to receive a lighting device and a switch hole configured to receive the switch.

In another aspect combinable with the general implementation, the roller shading cover comprises a left side rail, a right side rail, and a rail supporting panel extended from the left side rail to the right side rail, wherein the rail supporting panel is arranged adjacent to a front wall of the cargo box opening.

While this specification contains many specific implementation details, these should not be construed as limitations on the scope of any inventions or what may be claimed but rather as descriptions of features specific to particular implementations of particular inventions. Certain features that are described in this specification in the context of separate implementations can also be implemented in combination in a single implementation. Conversely, various features described in the context of a single implementation can also be implemented in multiple implementations separately or in any suitable subcombination. Moreover, although features may be described above and below as acting in certain combinations and even initially claimed as such, one or more features from a claimed combination can, in some cases, be excised from the combination, and the claimed combination may be directed to a subcombination or variation of a subcombination.

Several implementations have been described. Nevertheless, it will be understood that various modifications may be made without departing from the spirit and scope of the disclosure. For example, the operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might need to be of a more precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of a roller shading arrangement for a vehicle according to an aspect of the embodiment.

FIG. 2 is an exploded view of the roller shading arrangement according to an aspect of the embodiment.

FIG. 3 is another exploded view of the roller shading arrangement according to an aspect of the embodiments.

FIG. 4 illustrates a roller shading cover in a closed position according to an aspect of the embodiments.

FIG. 5 illustrates the roller shading cover in an open position according to an aspect of the embodiments.

FIG. 6 is a sectional view of the roller shading cover having a solar panel affixed thereon according to an aspect of the embodiment.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein and all of the equivalents thereof. Further, the structures, materials, or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

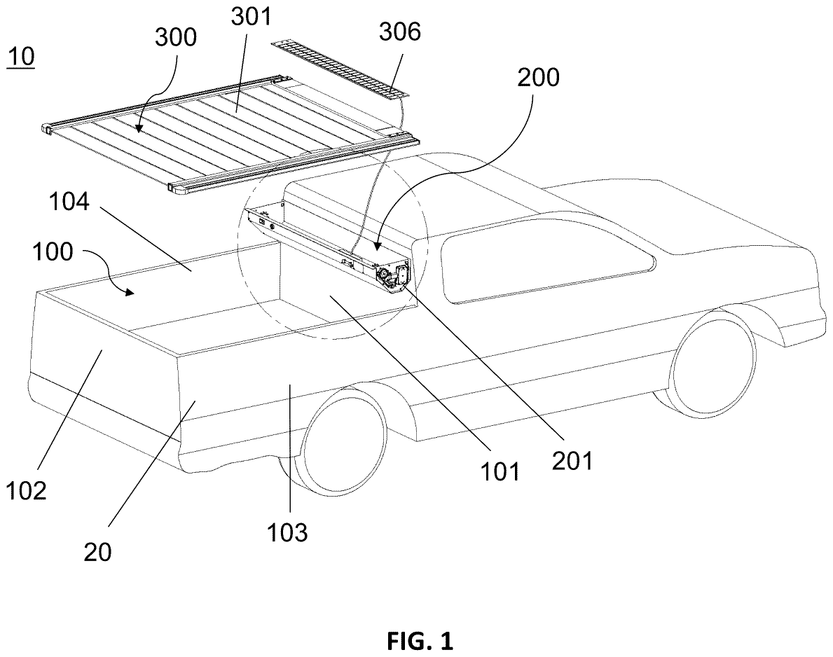

FIGS. 1-3 generally depict a roller shading arrangement 10 for a cargo box 20 of a vehicle according to an aspect of the embodiments.

Referring to FIG. 1, the roller shading arrangement 10 for the cargo box 20 of the vehicle may comprise a cargo box opening 100, a driving assembly 200 comprising a protection box 201 located inside the cargo box 20, a roller shading cover 300 comprising a plurality of slats 301 movable between an open position and a closed position, and a solar panel 306 electrically connected with the driving assembly 200 and arranged on the driving assembly 200 and the cargo box opening 100.

In some embodiments, the cargo box opening 100 may comprise a front wall 101, a rear wall 102, and left and right walls 104, 103 extended therebetween, wherein the protection box 201 is mounted on the front wall 101.

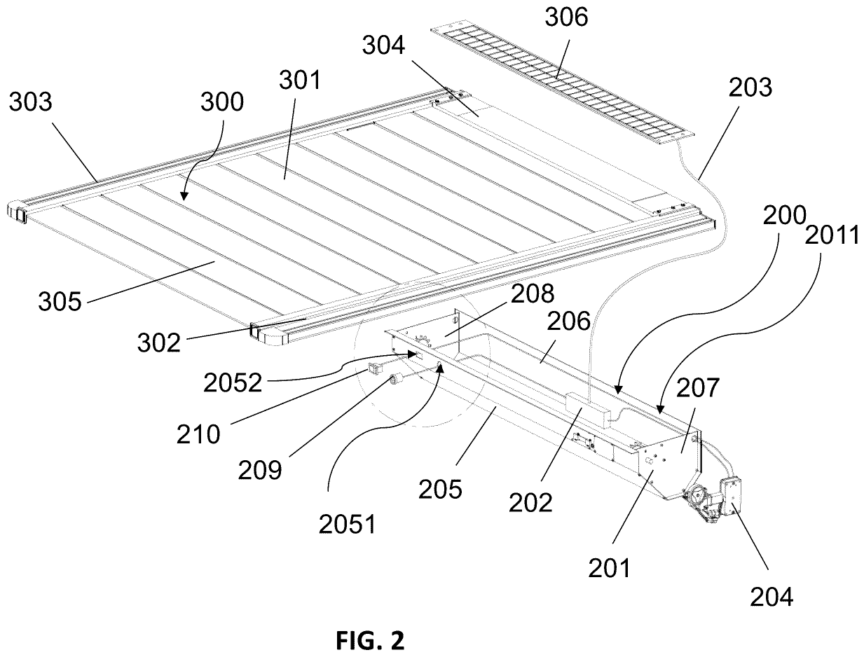

Continuing to FIG. 2, the driving assembly 200 may comprise a driver 202 positioned inside the protection box 201, at least one first electrical wire 203 received inside the protection box 201 and configured to connect the solar panel 306 electrically and the driver 202, and a battery component 204 arranged outside the protection box 201.

In still some embodiments, the roller shading cover 300 may comprise a left side rail 303 and a right side rail 302, wherein the left side rail 303 is supportable along and on the left wall 104 of the cargo box opening 100, and the right side rail 302 is supportable along and on the right wall 103 of the cargo box opening 100, wherein the roller shading cover 300 may further comprise a rail supporting panel 304 extended between the left side rail 303 and the right side rail 302 and securely affixed on the left side rail 303 and the right side rail 302.

It should be noted that, in some embodiments, the solar panel 306 may be affixed to the rail supporting panel 304 and configured to receive heat energy from the sun. In some embodiments, the roller shading cover 300 may comprise an inner surface facing the cargo box opening 100 and an outer surface 305 exposed outside, wherein the rail supporting panel 304 may be arranged on the outer surface 305, and at the same time, the solar panel 306 is affixed on the rail supporting panel 304 in order to facilitate the solar panel 306 for receiving the heat energy from the sunlight.

In still some embodiments, the protection box 201 may have a box front wall 205, a box rear wall 206, a box left side wall 208, and a box right side wall 207 integrally extended between the box front wall 205 and the box rear wall 206, wherein the box front wall 205 may comprise a lighting hole 2051 configured to receive a lighting device 209 and a switch hole 2052 configured to receive a switch 210.

As shown in further detail in FIG. 2, the protection box 201 may comprise a box opening 2011 formed by free ends of the box front wall 205, the box rear wall 206, the box left side wall 208, and the box right side wall 207, wherein the battery component 204 may be secured on the box left side wall 208 or the box right side wall 207.

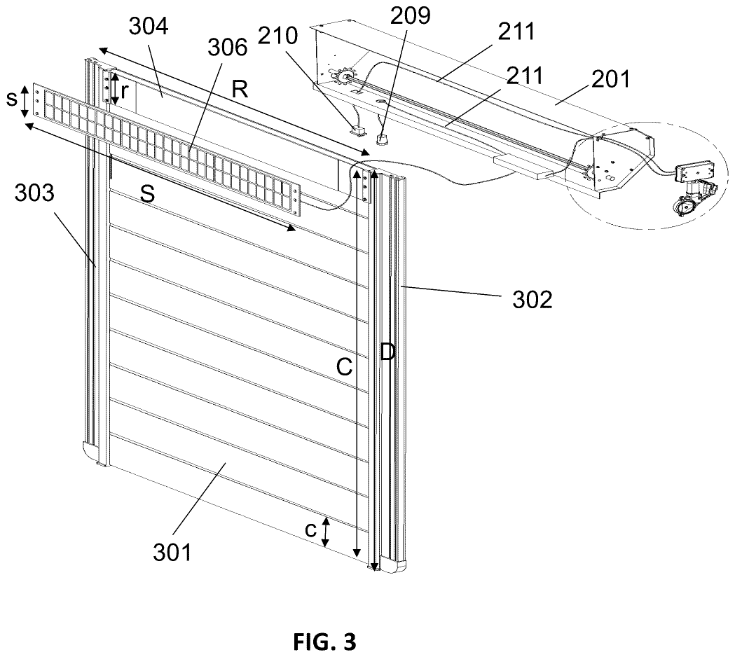

Referring to FIG. 3, in still some embodiments, the solar panel 306 may comprise a solar panel length “S” and a solar panel width “s”, and the rail supporting panel 304 may comprise a rail supporting panel length “R” and a rail supporting panel width “r,” wherein the solar panel length “S” is equal to the rail supporting panel length “R,” and the solar panel width “s” is equal to the rail supporting panel width “r,” and in such a way, the rial supporting panel 304 may be completely covered by the solar panel 306 while the solar panel 306 is affixed thereon, and at this situation, the overall appearance could be more simple and elegant.

In still some embodiments, the plurality of slats 301 may be coupled together to define a roller shading length “C” which is defined as a sum amount of each width “c” of each of the plurality of the slats 301, wherein each of left and right side rails 303, 302 define a left side rail length “D” and a right side rail length “D” respectively, wherein the left side rail length “D” is longer than the roller shading length “C”, and the right side rail length “D” is longer than the roller shading length “C.” It should be noted that, in some embodiments, the left side rail 303 and the right side rail 302 are two identical rails, and the left side rail 303 is symmetrically arranged with the right side rail 302 along each of the plurality of the slats 301, and in such a way, the left side rail length “D” is equal to the right side rail length “D.”

In still some embodiments, the roller shading arrangement 10 may further comprise at least one second electrical wire 211 embedded inside the protection box 201, wherein the lighting device 209 is electrically connected with the solar panel 306 through the second electrical wire 211, and the switch 210 is electrically connected with the solar panel 306 through the second electrical wire 211.

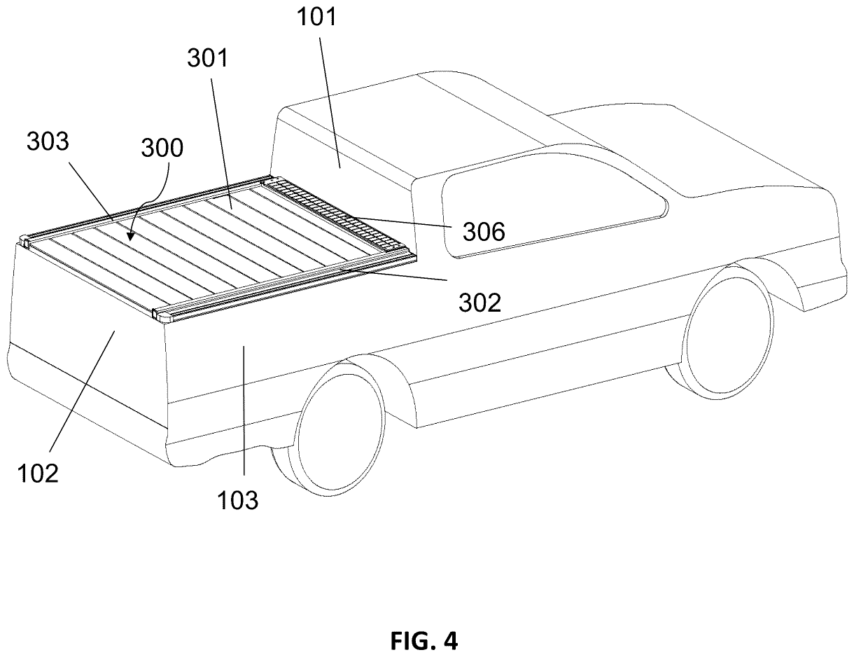

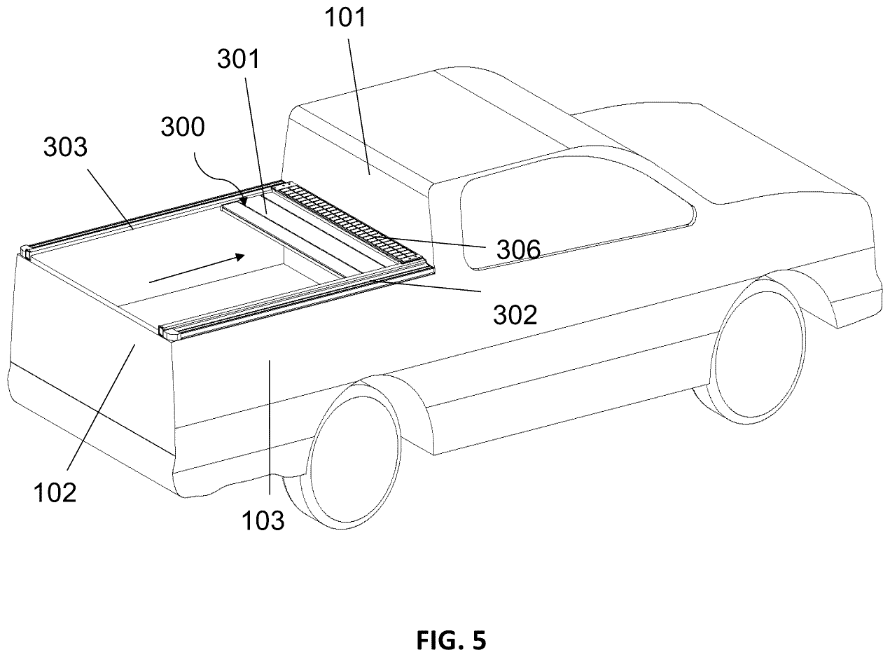

FIGS. 4-5 generally depict the roller shading cover 300 in the open and closed positions according to an aspect of the embodiments.

Referring to FIG. 4, in some embodiments, in the closed position of the roller shading cover 300, at this situation, the left side rail 303 is affixed along the left wall 104 (shown in FIG. 1) of the cargo box opening 100, and the right side rail 302 is affixed along the right wall 103 of the cargo box opening 100. The rail supporting panel 304 is affixed on the front wall 101 of the cargo box opening 100. At the same time, all the slats 301 of roller shading cover 300 are longitudinally expanded until the rear wall 102 of the cargo box opening 100 and completely covers the cargo box opening 100.

It should be noted that, in some embodiments, in the closed position, the box opening 2011 of the protection box 201 (shown in FIG. 2) may be completely covered by the rail supporting panel 304, and the solar panel 306 is affixed on the rail supporting panel 304.

Referring to FIG. 5, in some embodiments, in the open position of the roller shading cover 300, the plurality of slats 301 of the roller shading cover 300 may be coupled together where the slats 301 may be longitudinally retracted towards the solar panel 306 and the rail supporting panel 304 to allow access to the cargo box opening 100.

Continuing to FIGS. 4-5, in some embodiments (as referring back to FIG. 1), the rail supporting panel 304 may be extended from the left side rail 303 to the right side rail 302, wherein the rail supporting panel 304 may be arranged adjacent to the front wall 101 of the cargo box opening 100, and in such a way, while the roller shading cover 300 is performed from the closed position to the open position, the slats 301 are retracted from the rear wall 102 of the cargo box opening 100 to the front wall 101 of the cargo box opening 100, and in such a way, the slats 301 may be continuously retracted and received under the rail supporting panel 304.

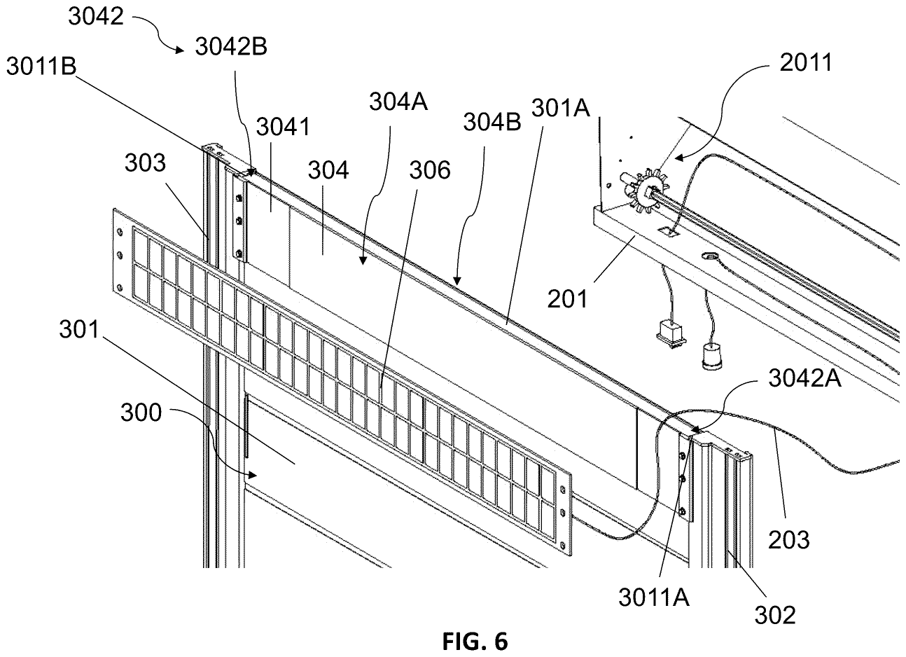

FIG. 6 generally depicts a sectional view of the rail supporting panel 304 and the solar panel 306 affixed thereon according to an aspect of the embodiments.

Referring to FIG. 6, in some embodiments, the rail supporting panel 304 may comprise at least one surface indentation 3041 integrally and inwardly extended from an outer surface 304A of the rail supporting panel 304, wherein an inner surface 304B of the rail supporting panel 304 may be facing towards the box opening 2011 of the protection box 201, and in such a way, the at least one first electrical wire 203 of the driving assembly may be embedded inside the surface indentation 3041 while the solar panel 306 is affixed on the rail supporting panel 304. It should be noted that, in some embodiments, the surface indentation 3041 may be configured to receive the first electrical wire 203 while the solar panel 306 is affixed on the rail supporting panel 304, and at the same time, the first electrical wire 203 may be passed through the surface indentation 3041 and extended to the driver located inside the protection box 201.

As shown in further detail in FIG. 6, in still some embodiments, the roller shading cover 300 may further comprise at least one side indentation 3042 including a left side indentation 3042B and a right side indentation 3042A formed by one of the plurality of the slats 301, the left side rail 303 or the right side rail 302, and the rail supporting panel 304, wherein while the left side rail 303 and the right side rail 302 are mounted on each of the plurality of slats 301, the left side rail 303 and the right side rail 302 are protruded from an end slat 301A of the plurality of slats 301, and in such a way, the left side indentation 3042B may be formed between the left side rail 303, a left end 3011B of the end slat 301A, and the rail supporting panel 304 affixed on the end slats 301A, and in other words, the right side indentation 3042A may also be formed between the right side rail 302, a right end 3011A of the end slat 301A, and the rail supporting panel 304 affixed on the end slats 301A, wherein the left end 3011B of the end slat 301A may be opposite of the right end 3011A of the end slat 301A.

It should be noted that, in some embodiments, the first electrical wire 203 of the driving assembly may be embedded inside the side indentation 3042 (either the left side indentation 3042B or the right side indentation 3042A) while the first electrical wire 203 is passed through (or embedded inside) the surface indentation 3042 of the rail supporting panel 304. It should be noted that, in some embodiments, to affix the solar panel 306 on the rail supporting panel 304 and connect the solar panel 306 with the driver located inside the protection box 201, the first electrical wire 203 may be passed through the surface indentation 3041 and the side indentation 3042 to be extended inside the protection box 201.

Many alterations and modifications may be made by those having ordinary skill in the art without departing from the spirit and scope of the disclosed embodiments. Therefore, it must be understood that the illustrated embodiments have been set forth only for the purposes of example and should not be taken as limiting the embodiments as defined by the following claims. For example, even though the elements of a claim are set forth below in a certain combination, it must be expressly understood that the embodiment includes other combinations of fewer, more, or different elements disclosed herein even when not initially claimed in such combinations.

Thus, specific embodiments and applications of the roller shading arrangement for the vehicle have been disclosed. It should be apparent, however, to those skilled in the art that many more modifications besides those already described are possible without departing from the disclosed concepts herein. Therefore, the disclosed embodiments are not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced. Insubstantial changes from the claimed subject matter as viewed by a person with ordinary skill in the art, now known or later devised, are expressly contemplated as equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be substituted, and what essentially incorporates the essential idea of the embodiments. In addition, where the specification and claims refer to at least one of something selected from the group consisting of A, B, C . . . . and N, the text should be interpreted as requiring at least one element from the group which includes N, not A plus N, or B plus N, etc.

The words used in this specification to describe the various embodiments are to be understood not only in the sense of their commonly defined meanings but to include by special definition in this specification structure, material, or acts beyond the scope of the commonly defined meanings. Thus, if an element can be understood in this specification as including more than one meaning, its use in a claim must be understood as being generic to all possible meanings supported by the specification and the word itself.

Therefore, the definitions of the words or elements of the following claims include not only the combination of elements set forth but all equivalent structures, materials, or acts for performing substantially the same function in the same way to obtain the same result. Therefore, it is contemplated that an equivalent substitution of two or more elements may be made for any of the elements in the claims below or that a single element may be substituted for two or more elements in a claim. Although elements may be described above as acting in certain combinations and even initially claimed as such, it is to be expressly understood that one or more elements from a claimed combination can, in some cases, be excised from the combination and that the claimed combination may be directed to a subcombination or variation of a subcombination.

What is claimed is:

1. Roller shading arrangement for a cargo box of a vehicle, comprising:
a cargo box opening;
a driving assembly comprising a protection box located inside the cargo box;
a roller shading cover comprising a plurality of slats movable between an open position and a closed position; and
a solar panel electrically connected with the driving assembly and arranged above the driving assembly and the cargo box opening.

2. The roller shading arrangement of claim 1, wherein the driving assembly comprises a driver positioned inside the protection box, at least one first electrical wire received inside the protection box and configured to electrically connect the solar panel and the driver.

3. The roller shading arrangement of claim 2, wherein the cargo box opening comprises a front wall, a rear wall, a left wall extending between the front wall and the rear wall, a right wall extending between the front wall and the rear wall, wherein the protection box is mounted on the front wall.

4. The roller shading arrangement of claim 2, wherein the roller shading cover comprises a left side rail supportable along and on the left wall, a right side rail supportable along and one the right wall, and a rail supporting panel extended between the left and right side rails and affixed on the left and right side rails.

5. The roller shading arrangement of claim 4, wherein the driving assembly comprises a protection box having a box opening, wherein the box opening is completely covered by the rail supporting panel, and the solar panel is affixed on the rail supporting panel.

6. The roller shading arrangement of claim 4, wherein the plurality of slats are coupled together in the open position where the slats are longitudinally retracted towards the rail supporting panel to allow access to the cargo box opening, and in the closed position, the slats are longitudinally expanded to cover the cargo box opening.

7. The roller shading arrangement of claim 4, wherein the solar panel comprises a solar panel length and a solar panel width, and the rail supporting panel comprises a rail supporting panel length and a rail supporting panel width, wherein the solar panel length is equal to the rail supporting panel length, and the solar panel width is equal to the rail supporting panel width.

8. The roller shading arrangement of claim 4, wherein the rail supporting panel comprises at least one surface indentation inwardly extended from an outer surface of the rail supporting panel, wherein at least one first electrical wire of the driving assembly is embedded inside the surface indentation while the solar panel is affixed on the rail supporting panel.

9. The roller shading arrangement of claim 4, wherein the plurality of slats are coupled together to define a roller shading length which is defined as a sum amount of each of a slat width of the plurality of the slats, wherein each of the left and right side rails define a left side rail length and a right side rail length, wherein the left and right side rail lengths are longer than the roller shading length.

10. The roller shading arrangement of claim 4, wherein the roller shading cover comprises a side indentation formed by one of the plurality of the slats, the left side rail or the right side rail, and the rail supporting panel, wherein at least one first electrical wire of the driving assembly is embedded inside a surface indentation of the rail supporting panel and the side indentation while the solar panel is affixed on the rail supporting panel.

11. The roller shading arrangement of claim 1, further comprising a lighting device electrically connected with the solar panel, a switch electrically connected with the solar panel, and at least one second electrical wire embedded inside the protection box and configured to electrically connected the lighting device and the switch with the solar panel.

12. The roller shading arrangement of claim 1, wherein the protection box has a box front wall, a box rear wall, box left and box right side walls integrally extended between the box front wall and the box rear wall, wherein the box front wall comprises a lighting hole configured to receive a lighting device and a switch hole configured to receive a switch.

13. The roller shading arrangement of claim 1, wherein the roller shading cover comprises a left side rail, a right side rail, and a rail supporting panel extended from the left side rail to the right side rail, wherein the rail supporting panel is arranged adjacent to a front wall of the cargo box opening.
